(19) United States
(12) Patent Application Publication
(10) Pub. No.: US 2019/0102923 A1
(43) Pub. Date: Apr. 4, 2019

(54) COMBINING SYNTHETIC IMAGERY WITH REAL IMAGERY FOR VEHICULAR OPERATIONS

(71) Applicant: L3 Technologies, Inc., New York, NY (US)

(72) Inventor: Paul Albert Voisin, Alto, MI (US)

(73) Assignee: L3 Technologies, Inc., New York, NY (US)

(21) Appl. No.: 15/724,667

(22) Filed: Oct. 4, 2017

(51) Int. Cl. G06T 11/60; H04N 7/18; G06T 7/13; H04N 5/232; B64D 43/00

(52) U.S. Cl. CPC G06T 11/60; H04N 7/181; G06T 7/13; H04N 5/23293; B64D 43/00; B64D 2011/0061; G06T 2207/30268; G06T 2207/10016; G06T 2207/20212; G06T 2207/30204; G06T 2207/10032

(57) ABSTRACT

Various display systems may benefit from the combination of synthetic imagery from a plurality of sources. For example, display systems for vehicular operations may benefit from combining synthetic imagery with real imagery. A method can include obtaining, by a processor, an interior video image based on a position of a user. The method can also include obtaining, by the processor, an exterior video image based on the position of the user. The method can further include combining the interior video image and the exterior video image to form a combined single view for the user. The method can additionally include providing the combined single view to a display of the user.

### BACKGROUND

### Field

Various display systems may benefit from the combination of synthetic imagery from a plurality of sources. For example, display systems for vehicular operations may benefit from combining synthetic imagery with real imagery.

### Description of the Related Art

Since the 1920s, aircraft makers have incorporated instruments into planes, in order to permit operation of planes in limited or zero visibility conditions. Traditionally, these instruments were located on an instrument panel. Thus, it was necessary for the pilot to look away from the windows of the aircraft in order to verify the flight conditions using the instruments.

More recently, synthetic image displays show an outside view on the instrument panel. Also, in the case of certain military aircraft, such as F-18s, a heads up display (HUD) can provide a visual display of certain aircraft parameters, such as attitude, altitude, and the like. Furthermore, in some cases, display glasses can provide HUD-like imagery to a user.

Major aircraft modifications may be required to install a HUD. Certain installations must typically be boresighted, and the viewing box can be very limited. Synthetic image displays require the pilot to look down at the instruments while on approach and cross check the windscreen to find the runway environment. The image is limited in size and focal distance of the pilot must change, from near to far, back to near, and so on. Display glasses may have to collimate the image to create the same focal distance as the outside environment; otherwise, the image may be blurry.

### SUMMARY

According to certain embodiments of the present invention, a method can include obtaining, by a processor, an interior video image based on a position of a user. The method can also include obtaining, by the processor, an exterior video image based on the position of the user. The method can further include combining the interior video image and the exterior video image to form a combined single view for the user. The method can additionally include providing the combined single view to a display of the user.

In certain embodiments of the present invention, an apparatus can include at least one processor and at least one memory including computer program code. The at least one memory and the computer program code can be configured to, with the at least one processor, cause the apparatus at least to obtain an interior video image based on a position of a user. The at least one memory and the computer program code can also be configured to, with the at least one processor, cause the apparatus at least to obtain an exterior video image based on the position of the user. The at least one memory and the computer program code can further be configured to, with the at least one processor, cause the apparatus at least to combine the interior video image and the exterior video image to form a combined single view for the user. The at least one memory and the computer program code can additionally be configured to, with the at least one processor, cause the apparatus at least to provide the combined single view to a display of the user.

An apparatus, in certain embodiments of the present invention, can include means for obtaining, by a processor, an interior video image based on a position of a user. The apparatus can also include means for obtaining, by the processor, an exterior video image based on the position of the user. The apparatus can further include means for combining the interior video image and the exterior video image to form a combined single view for the user. The apparatus can additionally include means for providing the combined single view to a display of the user.

A system, according to certain embodiments of the present invention, can include a first camera configured to provide a near focus view of surroundings of a user. The system can also include a second camera configured to provide a distance focus view of the surroundings of the user. The system can further include a processor configured to provide a combined view of the surroundings based on the near focus view and the distance focus view. The system can additionally include a display configured to display the combined view to the user.

### BRIEF DESCRIPTION OF THE DRAWINGS

For proper understanding of the invention, reference should be made to the accompanying drawings, wherein:

FIG. 1 illustrates markers, according to certain embodiments of the present invention.

FIG. 2 illustrates a mapping of mask areas, according to certain embodiments of the present invention.

FIG. 3 illustrates display glasses, according to certain embodiments of the present invention.

FIG. 4 illustrates a synthetic image mapped to a window, according to certain embodiments of the present invention.

FIG. 5 illustrates a camera image mapped to a window, according to certain embodiments of the present invention.

FIG. 6 illustrates a system, according to certain embodiments of the present invention.

FIG. 7 illustrates a method, according to certain embodiments of the present invention.

FIG. 8 illustrates a further system, according to certain embodiments of the present invention.

### DETAILED DESCRIPTION

Certain embodiments of the present invention provide mechanisms, systems, and methods for vehicle operators who may encounter limited visibility due to, among other things, obscuration to maintain reference to the outside environment and to the vehicle instruments/interior. This obscuration may be from, for example, clouds, smoke, fog, night, snow, or the like.

Certain embodiments of the present invention may display a synthetic image in the windscreen area, not just on the instrument panel. This synthetic image may appear larger to the pilot than traditional synthetic images. Moreover, the pilot may be able to avoid or limit cross-checking between the instrument panels and the windscreen.

The synthetic image can be in full color and can contain all major features or a subset thereof. Moreover, the instrument panel and the interior can still be visible. Furthermore, collimating optics can be avoided. All imagery can be presented at the same focal distance for the user.

Certain embodiments of the present invention may align the synthetic image to the cockpit environment. Edge and/or object detection can be used to automatically update image alignment.

Certain embodiments of the present invention can be applied to flying vehicles, such as airplanes. Nevertheless, other embodiments of the present invention may be applied to other categories of vehicles, such as boats, amphibious vehicles, such as hovercraft, wheeled vehicles, such as cars and trucks, or treaded vehicles, such as snowmobiles.

Certain embodiments of the present invention can provide devices and methods for combining a real time synthetic image of the outside environment with real time video imagery. As will be described below, some of the components of a system can include a system processor, markers, and display glasses.

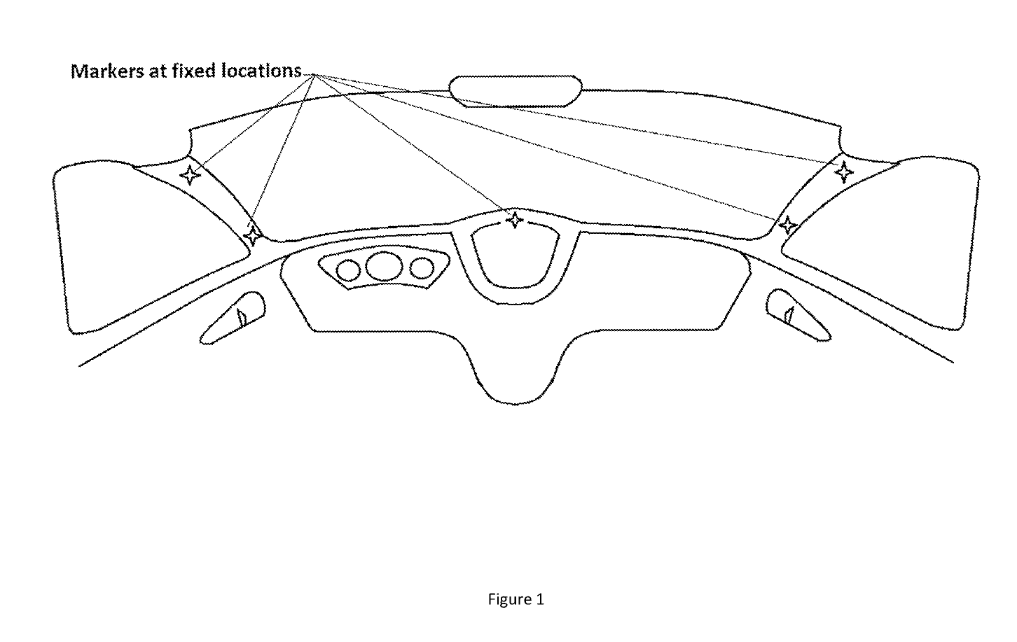

FIG. 1 illustrates markers, according to certain embodiments of the present invention. As shown in FIG. 1, markers can be installed at fixed locations within a cockpit. These markers can be selected to be any recognizable form of marker, such as a marker having a particular predefined geometry, color, pattern, or reflectivity. As shown, a plurality of markers can be placed at predetermined locations throughout the cockpit. The example of a cockpit is used, but other locations such as the bridge of a ship or a yacht or the driver's seat area of a car can be similarly equipped. The markers can be located throughout a visual domain of the vehicle operator (for example, a pilot). Thus, the position of markers can be distributed such that at least one marker will typically be visible within the field of vision of the operator during vehicle operation.

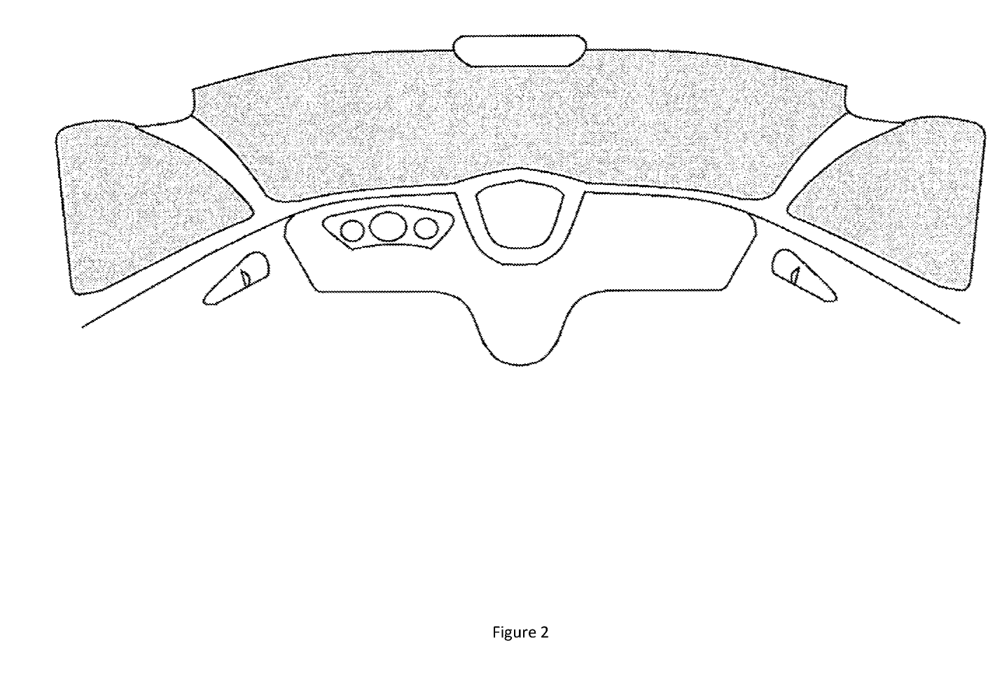

FIG. 2 illustrates a mapping of mask areas, according to certain embodiments of the present invention. As shown in FIG. 2, the mask areas can correspond to the windscreen and other windows within the cockpit area.

Display glasses that may be employed with embodiments of the present invention may contain built in video camera(s), an infra-red emitter and 3-axis angular rate gyros. Typical applications are for vehicles, such as aircraft or cars.

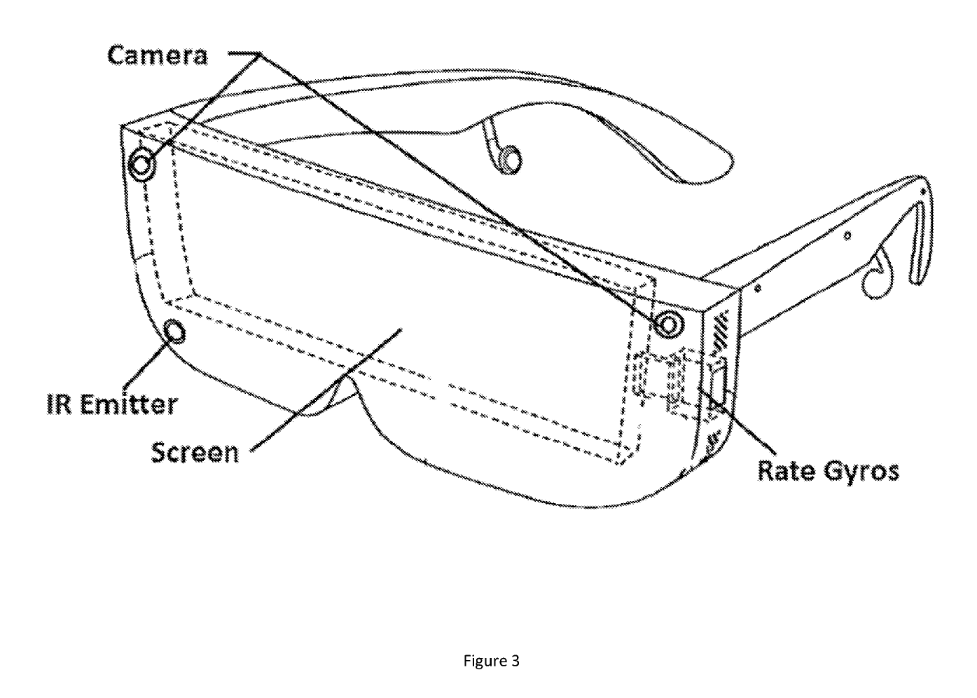

FIG. 3 illustrates display glasses, according to certain embodiments of the present invention. As shown in FIG. 3, video camera(s) can be mounted on the display glasses facing forward and can provide focused imagery for both near (interior) and distance (exterior) processing.

The display glasses can also include an infrared (IR) emitter. The IR emitter can be used to illuminate the markers, which may be designed to reflect IR light particularly well. The display glasses can also include rate gyros or other movement sensing devices, such as micro-electromechanical sensors (MEMS) or the like.

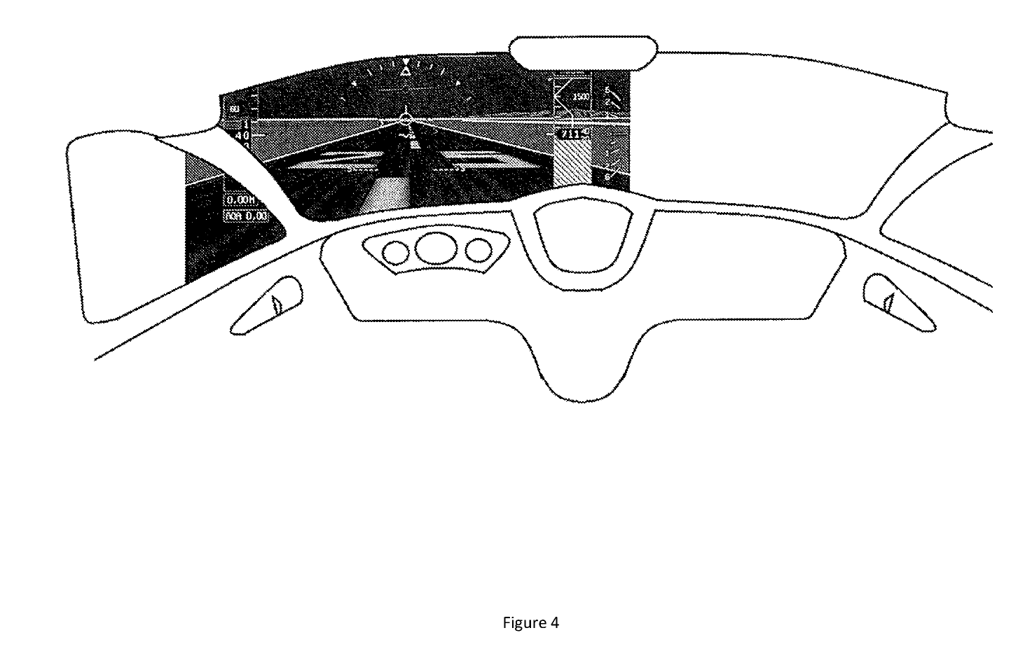

FIG. 4 illustrates a synthetic image mapped to a window, according to certain embodiments of the present invention. As shown in FIG. 4, the synthetic image can be mapped to one or more of the mask areas, such as those shown in FIG. 2. Although a single image is shown, optionally a stereoscopic image can be presented, such that each eye sees a slightly different image.

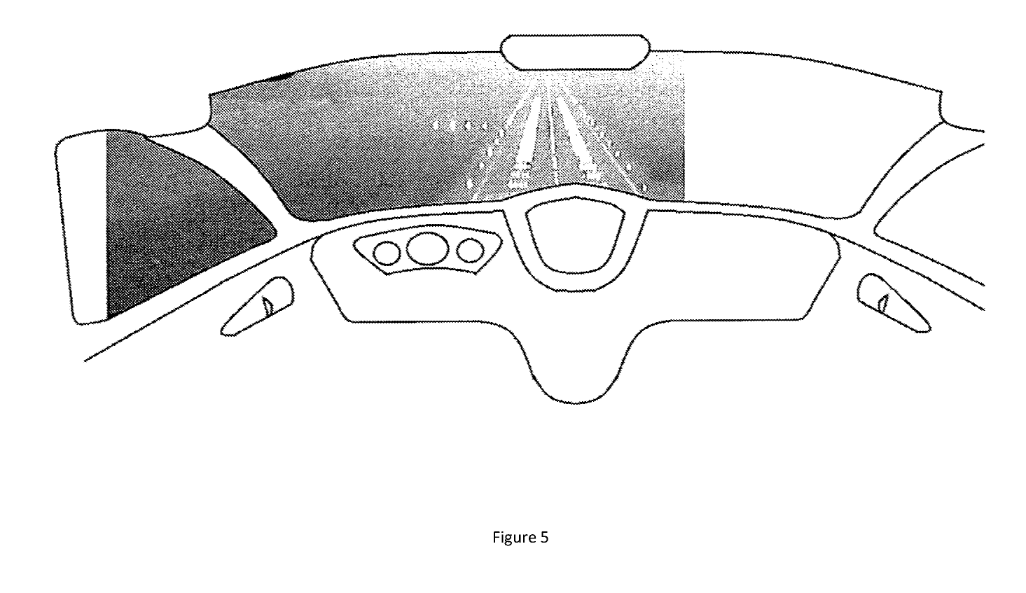

FIG. 5 illustrates a camera image mapped to a window, according to certain embodiments of the present invention. As shown in FIG. 5, the camera image can be mapped to one or more mask areas, such as those shown in FIG. 2. Although a single image is shown, optionally a stereoscopic image can be presented, such that each eye sees a slightly different image.

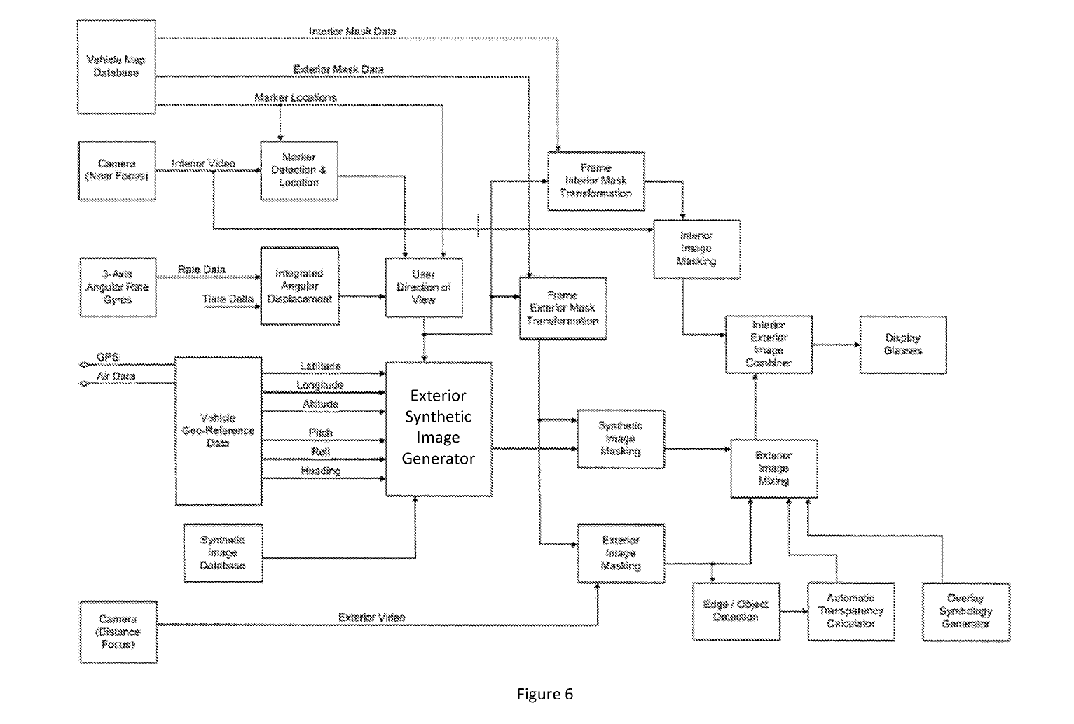

FIG. 6 illustrates a system, according to certain embodiments of the present invention. As shown in FIG. 6, the system can include a near focus camera and a distance focus camera. Although only one of each camera is shown, a plurality of cameras can be provided, for example to provide a stereoscopic image or a telephoto option.

The distance focus camera can provide exterior video to an exterior image masking section. The exterior image masking section can be implemented in a processor, such as a graphics processor. The exterior video can refer to video corresponding to the exterior of the vehicle, such as the environment of an airplane.

The near focus camera can provide interior video to an interior image masking section. The interior image masking section can be implemented in a processor, such as a graphics processor. This may be the same processor as for the exterior video masking section, or it may be a different processor. In certain cases, the system may include a multicore processor, and the interior image masking section and exterior image masking section can be implemented in different threads on different cores of the multicore processor.

The interior video can refer to video corresponding to the interior of the vehicle, such as the cockpit of an airplane. The interior video can also be provided to a marker detection and location section. Although not shown, the exterior video can optionally also be provided to this same marker detection and location section. If the focus of the exterior video is set to be longer than the interior walls of the cockpit, the exterior video may not be as useful for marker detection and location, as the markers may be out of focus. The marker detection and location section can be implemented in the same or different processor(s) as those discussed above. Optionally, each processing section of this system may be implemented in one or many processors, and in one or many threads on such processors. For ease of reading, each referenced “section” herein can be similarly embodied alone or in combination with any of the other identified sections, even when such is not explicitly stated in the following discussion.

Three-axis angular rate gyros or similar accelerometers, such as MEMS devices, can provide rate data to an integrated angular displacement section. The integrated angular displacement section can also receive time data, from a clock source. The clock source may be a local clock source, a radio clock source, or any other clock source, such as clock data from a global positioning system (GPS) source.

GPS and air data can be provided as inputs to a vehicle geo-reference data section. The vehicle geo-reference data section can provide detailed information about the vehicle (e.g., an aircraft) position and orientation, including such information as latitude, longitude, altitude, pitch, roll, heading or any other desired vehicle input. The information can include the current values of these, as well as rate or acceleration information regarding each of these.

The information from the vehicle geo-reference data section can be provided to an exterior synthetic image generator section. The exterior synthetic image generator section can also receive data from a synthetic image database. The synthetic image database may be local or remote. Optionally, a local synthetic image database can store data regarding the immediate vicinity of the aircraft or other vehicle. For example, all the synthetic image data for one hour or one fuel tank of range may be stored locally, while additional synthetic image data can be remotely stored and retrievable by the aircraft.

A vehicle map database can provide interior mask data to a frame interior mask transformation section. The vehicle map database can also provide exterior mask data to a frame exterior mask transformation section. The vehicle map database can additionally provide marker locations to the marker detection and location section and to a user direction of view section.

The vehicle map database and the synthetic image database can each or both be implemented using one or more memories. The memory may be any form of computer storage device, including optical storage, such as CD-ROM or DVD storage, magnetic storage, such as tape drive or floppy disk storage, or solid state storage, such as flash random access memory (RAM) or solid state drives (SSDs). Any non-transitory computer-readable medium may be used to store the databases. The same or any other non-transitory computer-readable medium may be used to store computer instructions, such as computer commands, to implement the various computing sections described herein. The database storage can be separate from or integrated with the computer command storage. Memory safety techniques, such as redundant arrays of inexpensive disks (RAID) can be employed. Backup of the memory can be performed locally or in a cloud system. Although not shown, the memory of the system can be in communication with a flight recorder and can provide details of the operational state(s) of the system to the flight recorder.

The marker detection and location section can provide information based on the near focus camera and maker locations to the user direction of view section. The user direction of view section can also receive integrated angular displacement data from the integrated angular displacement section. The user direction of view section can, in turn, provide information regarding the current direction a user is viewing to the frame interior mask transformation section, the frame exterior mask transformation section, and the exterior synthetic image generator.

The frame interior mask transformation section can provide interior mask transformation data based on the interior mask data and the user direction of view data. The interior mask transformation data can be provided to an interior image masking section. The interior image masking section can also receive the interior video from the near focus camera. The interior image masking section can provide interior image masking data to an interior exterior image combiner section.

The exterior synthetic image generator section can, based on data from the vehicle geo-reference data section, the synthetic image database, and the user direction of view section, provide an exterior synthetic image to the synthetic image masking section.

The synthetic image masking section can, based on the exterior synthetic image generator and the frame exterior mask transformation, create masked synthetic image data and provide such data to an exterior image mixing section.

The exterior image masking section can receive the frame exterior mask transformation data and the exterior video and can create a masked exterior image. The masked exterior image can be provided to the exterior image mixing section, as well as to an edge/object detection section. The edge/object detection section can provide output to an automatic transparency calculator section, which can, in turn, provide transparency information to the exterior image mixing section. An overlay symbology generator section can provide overlay symbology to the exterior image mixing section.

Based on its many inputs, the exterior image mixing section can provide an exterior image to the interior exterior image combiner section. The interior exterior image combiner section can combine the interior and exterior images and can provide them to display glasses.

Thus, as can be seen from FIG. 6 and the above discussion, a system processor in certain embodiments of the present invention can include vehicle geo-reference data, a synthetic imagery database, a synthetic image generator and components for manipulating and displaying video/image data_{[SPB1]}. Markers can be located within the user's normal field-of-view inside the vehicle's interior. The markers may be natural features, such as support columns, or intentionally placed fiducials. These can be features that may be provided in fixed positions relative to the visual obstacles of the interior. FIG. 1 provides an illustration of same example markers.

The processor can locate the markers in the video image and can use this information to determine the user's direction-of-view relative to the vehicle structure. The user's direction-of-view may change due to head movement, seat change, and the like.

During installation, exterior mask(s) and interior mask(s) can be determined relative to the vehicle structure, by the use of fixed markers. Typically, the exterior mask(s) can be the windscreen and windows; however, the exterior mask(s) can be arbitrarily defined, if desired. FIG. 2 provides an example of an exterior mask. The interior mask(s) can be the inverse of the exterior mask(s).

Thus, the interior mask(s) may typically be everything except the window areas. The interior mask(s) can also be arbitrarily defined. Typically, the interior mask(s) may include the instrument panel, the controls and the remainder of the vehicle interior. The exterior mask(s), interior mask(s) and marker locations can be stored in the vehicle map database.

Enhanced imagery can be selectively displayed in the exterior mask(s) and can be aligned to the user's direction-of-view. The level of image enhancement may vary from real time video, as illustrated in FIG. 5, to fully synthetic imagery, as illustrated in FIG. 4, or any combination thereof. Additional information, such as vehicle parameters, obstacles, and traffic, may also be included as an overlay in the enhanced imagery. The level of enhancement can be automatic or user selected.

Real time video imagery may be displayed in the interior mask(s) and may be aligned to the user's direction-of-view.

The processor can maintain orientation and alignment of the mask(s) relative to the vehicle structure by locating the fixed marker(s) in the camera(s) image frame. As the user's head moves, the mask(s) can move in the opposite direction.

The user's direction-of-view, the geo-reference data and the synthetic image database can be used to generate the real time synthetic imagery.

The geo-reference data for the vehicle can include any of the following: latitude, longitude, attitude (pitch, roll), heading (yaw), altitude or any other desired vehicle data. Such data can be provided by, for example, GPS, attitude gyros, air data sensors or any other desired vehicle system.

Long-term orientation of the user's direction-of-view can be based on locating the markers within the vehicle. This can be accomplished by numerous methods, such as reflection of an IR emitter signal or object detection via image analysis. Short term stabilization of the direction-of-view can be provided by the 3-axis rate gyro (or similar) data.

Integration of the rate gyro data can provide total angular displacement. This can be useful for characterizing the marker location(s) during installation. Once known, the movement of the marker(s) can be correlated to the user's actual direction-of-view.

Data for marker characterization can be collected by wearing the display glasses and scanning the entire allowable range of direction-of-view from the operator's station. For example, the display glasses can be used fully left, right, up, and down. The result can be a spherical or semi-spherical panoramic image.

Once the markers have been characterized, the exterior mask(s) and interior mask(s) can be determined. These masks(s) can be arbitrary and can be defined by several methods. For example, software tools can be used to edit the panoramic image. Another option is to use chroma key by applying green fabric to the windows or other areas and automatically detecting the green areas as mask areas. A further option is to detect and filter bright areas when the vehicle is in bright daylight.

Frame mask transformation can be variously accomplished. A transformation vector can be computed as the vector that will best move the marker(s) in the vehicle map database to the detected marker location(s) based on the user's direction of view. The frame exterior mask(s) and frame interior mask(s) can be computed using the transformation vector, exterior mask(s) and interior mask(s). The frame exterior mask(s) can be used to crop the exterior video and synthetic image. The frame interior mask(s) can be used to crop interior video. The vehicle exterior mask(s) and interior mask(s) do not need to be altered. The system can dither the boundary between the exterior and interior masks, such that the boundary may not be pronounced or distracting_{[SPB2]}.

Variable transparency can permit the generation of an enhanced image by mixing or combining exterior masked video and synthetic masked video. The transparency ratio, which can be an analog value, can be determined by the user or by an automatic algorithm. The automatic algorithm can process the masked exterior video data for edge detection. Higher definition of edges can cause the exterior masked video to become dominant. Conversely, lower edge detection can result in synthetic masked video becoming dominant.

The interior mask(s) can be the inverse of the exterior mask(s), as mentioned above. Therefore, the frame interior masked image can be combined with an enhanced image using a simple maximum value operation for each pixel. This can provide the user with imagery (real and enhanced) that is coherent with both the vehicle interior and the outside environment.

The alignment of the synthetic image to the outside environment can be accomplished via edge/object detection of visible features. This can happen on a continuous basis without user input.

The position of the sun relative to the direction of view may be known. Therefore, the sun may be tracked within the image and reduced in intensity, which may reduce and/or eliminate sun glare.

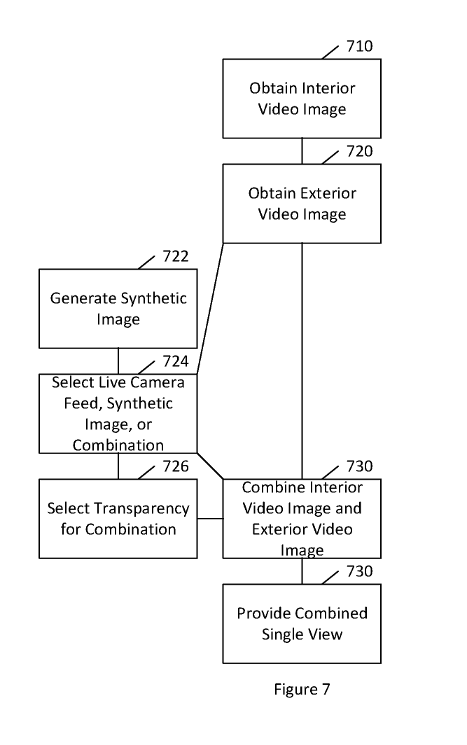

FIG. 7 illustrates a method, according to certain embodiments of the present invention. As shown in FIG. 7, a method can include, at 710, obtaining, by a processor, an interior video image based on a position of a user. The interior video image can be a live camera feed, for example a live video image of the interior of a cockpit as in the previous examples.

The method can also include, at 720, obtaining, by the processor, an exterior video image based on the position of the user. Obtaining the exterior video image can include, at 724, selecting from a live camera feed, a synthetic image, or a combination of the live camera feed and the synthetic image. The method can include, at 726, selecting a transparency for the combination of the live camera feed and the synthetic image. The method can also include, at 722, generating the synthetic image based on the position of the user. As described above, an alignment of the synthetic image can be determined based on at least one of edge detection or image detection from the interior video image. Edge detection and/or object detection can also be used to help decide whether to select the synthetic image, the live video image, or some combination thereof.

The method can further include, at 730, combining the interior video image and the exterior video image to form a combined single view for the user. The combined single view can be a live video image of a cockpit including the instrument panel view and a window view, as described above. The method can additionally include, at 740, providing the combined single view to a display of the user. The display can be glasses worn by the pilot of an aircraft. The display can be further configured to superimpose additional information similar to the way information is provided on a heads-up display.

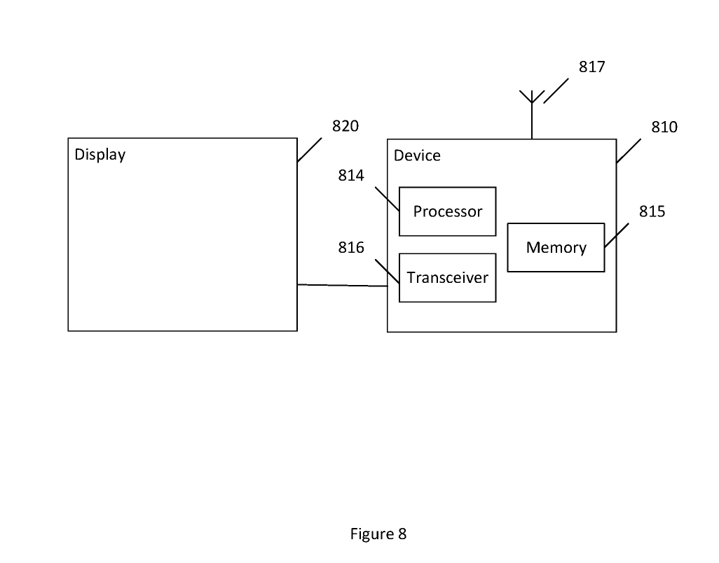

FIG. 8 illustrates an exemplary system, according to certain embodiments of the present invention. It should be understood that each block of the exemplary method of FIG. 7 may be implemented by various means or their combinations, such as hardware, software, firmware, one or more processors and/or circuitry. In one embodiment of the present invention, a system may include several devices, such as, for example, device 810 and display device 820. The system may include more than one display device 820 and more than one device 810, although only one of each is shown for the purposes of illustration. The device 810 may be any suitable piece of avionics hardware, such as a line replaceable unit of an avionics system. The display device 820 may be any desired display device, such as display glasses, which may provide a single image or a pair of coordinated stereoscopic images.

The device 810 may include at least one processor or control unit or module, indicated as 814. At least one memory may be provided in the device 810, indicated as 815. The memory 815 may include computer program instructions or computer code contained therein, for example, for carrying out the embodiments of the present invention, as described above. One or more transceivers 816 may be provided, and the device 810 may also include an antenna, illustrated as 817. Although only one antenna is shown, many antennas and multiple antenna elements may be provided for the device 810. Other configurations of the device 810, for example, may be provided. For example, device 810 may be configured for wired communication (as shown to connect to display device 820), in addition to or instead of wireless communication, and in such a case, antenna 817 may illustrate any form of communication hardware, without being limited to merely an antenna.

Transceiver 816 may be a transmitter, a receiver, or both a transmitter and a receiver, or a unit or a device that may be configured both for transmission and reception.

Processor 814 may be embodied by any computational or data processing device, such as a central processing unit (CPU), a digital signal processor (DSP), an application specific integrated circuit (ASIC), a programmable logic device (PLD), a field programmable gate array (FPGA), a digitally enhanced circuit, or a comparable device or a combination thereof. The processor 814 may be implemented as a single controller, or a plurality of controllers or processors. Additionally, the processor 814 may be implemented as a pool of processors in a local configuration, in a cloud configuration, or in a combination thereof. The term “circuitry” may refer to one or more electric or electronic circuits. The term “processor” may refer to circuitry, such as logic circuitry, that responds to and processes instructions that drive a computer.

For firmware or software, the implementation may include modules or units of at least one chip set (e.g., procedures, functions, and so on). Memory 815 may be any suitable storage device, such as a non-transitory computer-readable medium. A hard disk drive (HDD), random access memory (RAM), flash memory, or other suitable memory may be used. The memory 815 may be combined on a single integrated circuit as the processor, or may be separate therefrom. Furthermore, the computer program instructions which may be stored in the memory 815 and processed by the processor 814 can be any suitable form of computer program code, for example, a compiled or interpreted computer program written in any suitable programming language. The memory 815 or data storage entity is typically internal but may also be external or a combination thereof, such as in the case when additional memory capacity is obtained from a service provider. The memory may be fixed or removable.

The memory 815 and the computer program instructions may be configured, with the processor 814 for the particular device, to cause a hardware apparatus, such as device 810, to perform any of the processes described above (see, for example, FIG. 7). Therefore, in certain embodiments of the present invention, a non-transitory computer-readable medium may be encoded with computer instructions or one or more computer programs (such as added or updated software routines, applets or macros) that, when executed in hardware, may perform a process, such as one or more of the processes described herein. Computer programs may be coded by any programming language, which may be a high-level programming language, such as objective-C, C, C++, C#, Java, etc., or a low-level programming language, such as a machine language, or an assembler. Alternatively, certain embodiments of the invention may be performed entirely in hardware.

Further modifications to the above embodiments are possible. For example, various filters may be applied to both real and synthetic imagery, for example to provide balance or contrast enhancement, to highlight objects of interest, or to suppress visual distractions. In certain embodiments of the present invention, a left eye view may have a different combination of images than the right eye view. For example, the right eye view may be purely live video images, whereas the left eye view may have a synthetic exterior video image. Alternatively, one eye view may simply pass through the glasses transparently.

One having ordinary skill in the art will readily understand that the invention as discussed above may be practiced with steps in a different order, and/or with hardware elements in configurations which are different than those which are disclosed. Therefore, although the invention has been described based upon these disclosed embodiments, it would be apparent to those of skill in the art that certain modifications, variations, and alternative constructions would be apparent, while remaining within the spirit and scope of the invention.

We claim:

1. A method, comprising:
obtaining, by a processor, an interior video image based on a position of a user;
obtaining, by the processor, an exterior video image based on the position of the user;
combining the interior video image and the exterior video image to form a combined single view for the user; and
providing the combined single view to a display of the user.

2. The method of claim 1, wherein the interior video image comprises a live camera feed.

3. The method of claim 1, wherein the obtaining the exterior video image comprises selecting from a live camera feed, a synthetic image, or a combination of the live camera feed and the synthetic image.

4. The method of claim 3, further comprising:
selecting a transparency for the combination of the live camera feed and the synthetic image.

5. The method of claim 3, further comprising:
generating the synthetic image based on the position of the user.

6. The method of claim 5, wherein an alignment of the synthetic image is determined based on at least one of edge detection or image detection from the interior video image.

7. The method of claim 1, wherein the combined single view comprises a live video image of a cockpit including an instrument panel view and a window view.

8. An apparatus, comprising:
at least one processor; and
at least one memory including computer program code;
wherein the at least one memory and the computer program code are configured to, with the at least one processor, cause the apparatus at least to:
obtain an interior video image based on a position of a user;
obtain an exterior video image based on the position of the user;
combine the interior video image and the exterior video image to form a combined single view for the user; and
provide the combined single view to a display of the user.

9. The apparatus of claim 8, wherein the interior video image comprises a live camera feed.

10. The apparatus of claim 8, wherein the at least one memory and the computer program code are configured to, with the at least one processor, cause the apparatus at least to obtain the exterior video image by selecting from a live camera feed, a synthetic image, or a combination of the live camera feed and the synthetic image.

11. The apparatus of claim 10, wherein the at least one memory and the computer program code are configured to, with the at least one processor, cause the apparatus at least to select a transparency for the combination of the live camera feed and the synthetic image.

12. The apparatus of claim 10, wherein the at least one memory and the computer program code are configured to, with the at least one processor, cause the apparatus at least to generate the synthetic image based on the position of the user.

13. The apparatus of claim 12, wherein an alignment of the synthetic image is determined based on at least one of edge detection or image detection from the interior video image.

14. The apparatus of claim 8, wherein the combined single view comprises a live video image of a cockpit including an instrument panel view and a window view.

15. A system, comprising:
a first camera configured to provide a near focus view of surroundings of a user;
a second camera configured to provide a distance focus view of the surroundings of the user;
a processor configured to provide a combined view of the surroundings based on the near focus view and the distance focus view; and
a display configured to display the combined view to the user.

16. The system of claim 15, wherein the near focus view comprises a live camera feed.

17. The system of claim 15, wherein providing the combined view comprises selecting from a live camera feed, a synthetic image, or a combination of the live camera feed and the synthetic image.

18. The system of claim 17, wherein the processor is configured to select a transparency for the combination of the live camera feed and the synthetic image.

19. The system of claim 17, wherein the processor is configured to generate the synthetic image based on the position of the user.

20. The system of claim 17, wherein the processor is configured to align the synthetic image based on at least one of edge detection or image detection from the near focus view.
